(19) United States
(12) Patent Application Publication
(10) Pub. No.: US 2025/0091586 A1
(43) Pub. Date: Mar. 20, 2025

(54) VEHICLE EVACUATION DRILL MONITORING

(71) Applicant: IEE INTERNATIONAL ELECTRONICS & ENGINEERING S.A., Echternach (LU)

(72) Inventors: Joseph Michael FUNYAK, Rochester Hills, MI (US); Oliver DIEKMANN, Lake Orion, MI (US)

(21) Appl. No.: 18/886,961

(22) Filed: Sep. 16, 2024

Related U.S. Application Data
(60) Provisional application No. 63/538,684, filed on Sep. 15, 2023.

(51) Int. Cl. B60W 40/08; B60W 50/14; G04F 1/00

(52) U.S. Cl. CPC B60W 40/08; B60W 50/14; G04F 1/005; B60W 2040/0881

(57) ABSTRACT

A vehicle evacuation drill monitoring system and method for carrying out an evacuation drill for a vehicle in which occupants are evacuated from the vehicle. The vehicle evacuation drill monitoring system is configured to perform the method. The method includes the steps of: receiving a vehicle evacuation drill start input from an evacuation drill operator conducting a vehicle evacuation drill at a vehicle; initiating an evacuation countdown timer that defines a temporal extent of an evacuation phase of the vehicle evacuation drill in which one or more occupants are to evacuate a passenger cabin of the vehicle; upon expiration of the evacuation countdown timer, determining whether any occupants remain within the passenger cabin of the vehicle through use of occupant detection sensors installed within the vehicle; and providing an indicator indicating whether the vehicle evacuation drill was successful.

### TECHNICAL FIELD

This disclosure relates to monitoring individuals participating in an evacuation drill and, more particularly, monitoring individuals participating in an evacuation drill using occupant detection sensors installed within a passenger vehicle.

### BACKGROUND

Vehicle evacuation drills, such as school bus evacuation drills or other mass-transit evacuation drills, are performed by certain institutions and, indeed, are mandated in some jurisdictions to promote the safety of students and staff during emergencies while in transit. These drills are designed to familiarize passengers with the correct procedures for exiting the bus or vehicle quickly and safely, whether through regular doors, emergency exits, or even windows if circumstances necessitate. State and/or local laws often require schools to conduct these drills at specific intervals, such as at the beginning of each academic year or semester, and to document the execution, outcomes, and any challenges faced during these drills. Compliance with these mandates may not only be a legal obligation, but a critical measure of preparedness also. There is needed a way to verify that these vehicle evacuation drills have actually been performed and are performed successfully.

### SUMMARY

According to a first aspect, there is provided a method of carrying out an evacuation drill for a vehicle in which occupants are evacuated from the vehicle. The method is performed by a computer subsystem having at least one processor and memory storing computer instructions that, when executed by the at least one processor, cause the method to be performed. The method includes the steps of: receiving a vehicle evacuation drill start input from an evacuation drill operator conducting a vehicle evacuation drill at a vehicle; initiating an evacuation countdown timer that defines a temporal extent of an evacuation phase of the vehicle evacuation drill in which one or more occupants are to evacuate a passenger cabin of the vehicle; upon expiration of the evacuation countdown timer, determining whether any occupants remain within the passenger cabin of the vehicle through use of occupant detection sensors installed within the vehicle; and providing an indicator indicating whether the vehicle evacuation drill was successful.

According to embodiments, the method of the first aspect includes any of the following features or any technically-feasible combination of the following features:
when it is determined that no occupants remain within the passenger cabin of the vehicle, providing an evacuation drill successful execution indicator as the indicator and for indicating that the vehicle evacuation drill was successful;
when it is determined that an occupant remains within the passenger cabin of the vehicle, providing an evacuation drill unsuccessful execution indicator as the indicator and for indicating that the vehicle evacuation drill was unsuccessful;
determining whether any occupants are located within the passenger cabin of the vehicle prior to initiating the evacuation countdown timer;
the determination of whether any occupants are located within the passenger cabin of the vehicle prior to initiating the evacuation countdown timer is performed through use of the occupant detection sensors installed within the vehicle;
initiating the evacuation countdown timer when it is determined that there is at least one occupant located in the passenger cabin of the vehicle;
providing an evacuation drill incomplete execution indicator to the evacuation drill operator when it is determined that there is at least one occupant located in the passenger cabin of the vehicle;
the determination of whether any occupants are located within the passenger cabin of the vehicle prior to initiating the evacuation countdown timer is used for identifying whether the passenger cabin of the vehicle is in a ready state for performing the vehicle evacuation drill and/or whether the vehicle evacuation drill is being faked;
results of the vehicle evacuation drill are provided to a data management hub that is configured to obtain vehicle evacuation drill results from a plurality of vehicle evacuation drill monitoring systems including a first vehicle evacuation drill monitoring system having the computer subsystem and being for the vehicle;
the vehicle is a school bus or other mass-transit vehicle; and/or
the computer subsystem is installed on the school bus or other mass-transit vehicle.

According to a second aspect, there is provided a method of method of carrying out an evacuation drill for a vehicle in which occupants are evacuated from the vehicle. The method is performed by a computer subsystem having at least one processor and memory storing computer instructions that, when executed by the at least one processor, cause the method to be performed. The method includes the steps of: receiving a vehicle evacuation drill start input from an evacuation drill operator conducting a vehicle evacuation drill at a vehicle; in response to receiving the vehicle evacuation drill start input, activating occupant detection sensors that detect occupants present within a passenger cabin of the vehicle; determining whether one or more occupants are present within the passenger cabin; when it is determined that there are no occupants present within the passenger cabin, providing an evacuation drill incomplete execution indicator indicating that the evacuation drill is incomplete; and when it is determined that there are one or more occupants present within the passenger cabin: (i) initiating an evacuation countdown timer that defines a temporal extent of an evacuation phase of the evacuation drill in which the one or more occupants are to evacuate the passenger cabin of the vehicle; (ii) upon expiration of the evacuation countdown timer, determining whether any occupants remain within the passenger cabin of the vehicle through use of occupant detection sensors installed within the vehicle; (iii) when it is determined that no occupants remain within the passenger cabin of the vehicle, providing an evacuation drill successful execution indicator indicating that the evacuation drill was successful; and (iv) when it is determined that an occupant remains within the passenger cabin of the vehicle, providing an evacuation drill unsuccessful execution indicator indicating that the evacuation drill was unsuccessful.

According to embodiments, the method of the second aspect includes any of the features or any technically-feasible combination of the features recited above in connection with the method of the first aspect.

According to a third aspect, there is provided a vehicle evacuation drill monitoring system for a vehicle. The vehicle evacuation drill monitoring system includes: a computer subsystem having at least one processor and memory storing computer instructions; and one or more occupant detection sensors installed on the vehicle. The computer subsystem is configured to execute the computer instructions using the at least one processor in order to: receive a vehicle evacuation drill start input from an evacuation drill operator conducting a vehicle evacuation drill at a vehicle; initiate an evacuation countdown timer that defines a temporal extent of an evacuation phase of the vehicle evacuation drill in which one or more occupants are to evacuate a passenger cabin of the vehicle; upon expiration of the evacuation countdown timer, determine whether any occupants remain within the passenger cabin of the vehicle through use of occupant detection sensors installed within the vehicle; and provide an indicator indicating whether the vehicle evacuation drill was successful.

According to embodiments, the system of the third aspect includes any of the features or any technically-feasible combination of the features recited above in connection with the method of the first aspect.

### BRIEF DESCRIPTION OF THE DRAWINGS

Preferred exemplary embodiments will hereinafter be described in conjunction with the appended drawings, wherein like designations denote like elements, and wherein:

FIG. 1 is a block diagram depicting an embodiment of a vehicle evacuation drill monitoring system for a vehicle, according to at least one embodiment; and

FIG. 2 is a flowchart illustrating an exemplary method of method of carrying out an evacuation drill for a vehicle in which occupants are evacuated from the vehicle, according to at least one embodiment.

### DETAILED DESCRIPTION

There is provided a system and method for carrying out an evacuation drill for a vehicle in which occupants are evacuated from the vehicle. The system, which may be referred to as a vehicle evacuation drill monitoring system, is used to carry out the method, which is a method of carrying out an evacuation drill for a vehicle in which one or more occupants are evacuated from the vehicle. At least according to embodiments, the method includes the steps of: receiving a vehicle evacuation drill start input at a vehicle from an evacuation drill operator conducting an evacuation drill; initiating an evacuation countdown timer that defines a temporal extent of an evacuation phase of the evacuation drill in which one or more occupants are to evacuate a passenger cabin of the vehicle; and when it is determined that no occupants remain within the passenger cabin of the vehicle at of or before expiration of the evacuation countdown timer, providing an evacuation drill successful execution indicator indicating that the evacuation drill was successful.

According to embodiments, the vehicle evacuation drill monitoring system includes one or more occupant detection sensors (e.g., life detection sensors) installed in a vehicle, as well as a controller subsystem configured to receive sensor data from the one or more occupant detection sensors and to perform the method of carrying out an evacuation drill for the vehicle in which one or more occupants are evacuated from the vehicle. In embodiments, the vehicle evacuation drill monitoring system further includes a human-machine interface (HMI) output device, such as an audio speaker or an electronic display (e.g., liquid crystal display (LCD) screen), which is configured to receive an evacuation drill execution indicator from the controller subsystem and to provide the evacuation drill execution indicator to a user, such as an evacuation drill manager overseeing the vehicle evacuation drill. The evacuation drill execution indicator may be an evacuation drill unsuccessful execution indicator, evacuation drill successful execution indicator, or an evacuation drill incomplete execution indicator.

According to embodiments, the method further includes a fake evacuation drill detection mechanism that determines whether there are occupants present within the passenger cabin of the vehicle prior to beginning an evacuation phase of the evacuation drill. In embodiments, the fake evacuation drill detection mechanism is performed by activating occupant detection sensors that detect occupants present within a passenger cabin of the vehicle, which may be carried out in response to receiving the vehicle evacuation drill start input. The evacuation phase refers to a portion of the evacuation drill in which occupants are to evacuate the passenger cabin of the vehicle, which extends temporally from an evacuation start time to an evacuation end time. According to implementations, the fake evacuation drill detection mechanism enables verification of an evacuation drill being carried out at the vehicle through detecting occupants within the vehicle, such as within a passenger cabin of the vehicle. More specifically, the fake evacuation drill detection mechanism enables verification that occupants are located within the vehicle (specifically, the passenger cabin) at or prior to an evacuation start time whereat the evacuation phase of the evacuation drill begins.

According to embodiments, there is provided a data management hub that is configured to obtain vehicle evacuation drill execution results (e.g., the evacuation drill successful execution indicator, the evacuation drill unsuccessful execution indicator) from vehicle evacuation drill monitoring systems. In this regard, the data management hub is also referred to as an evacuation drill monitoring data hub or system that includes a computer system that is configured to receive vehicle evacuation drill execution results, which may be accompanied with other, related data, such as identification (e.g., phone number) of the evacuation drill operator (or vehicle operator, which may be the same individual), date and time of the vehicle evacuation drill execution results, and an amount of time the evacuation drill (or portion thereof, such as the evacuation phase) took.

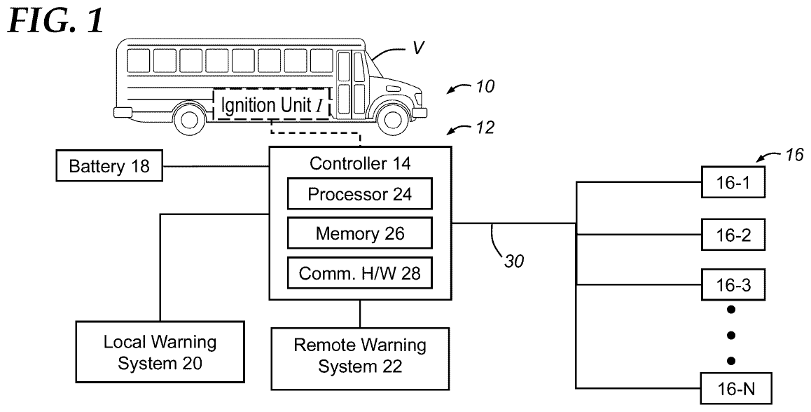

With reference to FIG. 1, there is shown an embodiment of a vehicle evacuation drill monitoring system 10 for a vehicle V (illustrated as a school bus in the depicted embodiment of FIG. 1), which includes a controller subsystem 12 with a controller 14, a plurality of occupant detection sensors 16, a battery 18, a local warning system 20, and a remote warning system 22. The vehicle evacuation drill monitoring system 10 may be installed on a vehicle with a passenger cabin, such as passenger vehicles (e.g., cars, trucks, SUVs) or mass-transit vehicles, such as busses, trains, marine vessels, aircraft, other mass-transit vehicles, etc.

The controller subsystem 12 includes the controller 14, and the controller 14 includes at least one processor 24 and memory 26 storing computer instructions that are executable by the at least one processor 24. The controller 14 also includes communications hardware (H/W), which may be short-range wireless communications (“SRWC”, also referred to as dedicated short-range wireless communications) and/or long-range communications. For example, the communications hardware 28 includes a Wi-Fi™ chipset, a Bluetooth™ chipset, and/or a cellular chipset. Although FIG. 1 depicts one controller 14 for the controller subsystem 12, in embodiments, the controller subsystem 12 may include a plurality of controllers and/or other various components, as appreciated by those skilled in the art, in order for the computer subsystem 12 to carry out its intended functionality. When the computer instructions are executed by the at least one processor 24, the controller subsystem 12 performs certain functionality as described herein. In particular, the controller subsystem 12 is used to perform one or more steps of the method discussed herein, and may be used to control certain aspects of the vehicle evacuation drill monitoring system 10. The at least one processor 24 of the controller subsystem 12 may be any type of device capable of processing electronic instructions including microprocessors, microcontrollers, host processors, controllers, vehicle communication processors, and application specific integrated circuits (ASICs). The memory 26 of the controller subsystem 12 may be one or more computer-readable mediums, such as a powered temporary memory or any suitable computer-readable medium; these include different types of RAM (random-access memory, including various types of dynamic RAM (DRAM) and static RAM (SRAM)), ROM (read-only memory), solid-state drives (SSDs) (including other solid-state storage such as solid state hybrid drives (SSHDs)), hard disk drives (HDDs), or magnetic or optical disc drives. Although the memory 26 is illustrated as being a part of the controller subsystem 12, in other embodiments, the memory 26 (or a portion thereof) can be a part of another device and can be communicatively coupled to the controller subsystem 12. As user herein, two devices being “communicatively coupled” means that at least one of the devices is able to send data and/or commands directly and/or indirectly to the other device.

The controller 14 is communicatively coupled to the one or more occupant detection sensors 16 and, in at least some embodiments, is communicatively coupled to the one or more occupant detection sensors 16 via a wired communications bus 30. In at least one embodiment, the controller subsystem 12 can direct, instruct, request, and/or otherwise cause the one or more occupant detection sensors 16 to capture sensor data through sending a sensor capture request to the one or more occupant detection sensors 16 via the communications bus 30. In other embodiments, in addition to or in lieu of a sensor capture request, the controller subsystem 12 may switch on operating power to the one or more occupant detection sensors 16 when scanning is desired and switch the power back off once the scan is complete. The one or more occupant detection sensors 16 may send the sensor data to the controller subsystem 12, which can include sampled sensor data or other information pertaining to the detection of an occupant (or lifeform), which will be discussed more below.

Also, according to various embodiments, the controller subsystem 12 is communicatively coupled to the ignition unit I of the vehicle V via a wired connection (e.g., a direct connection, via a communications bus) or wirelessly. The embodiment of FIG. 1 illustrates, by way of the dashed line, a wired connection between the ignition unit and the controller subsystem 12. The ignition unit I is an ignition unit of the vehicle on which the vehicle evacuation drill monitoring system 10 is installed. The ignition unit I can include circuitry that controls the ignition of the vehicle. The controller subsystem 12 can receive an indication that the ignition has been turned off and/or that the ignition has been turned on. In embodiments where the vehicle is an electric vehicle or hybrid vehicle, the controller subsystem 12 may be coupled to a primary propulsion control unit or a vehicle start system so that the controller subsystem 12 can receive an indication of a change in the primary propulsion of the vehicle or an indication that the vehicle has been started.

According to various embodiments, the controller subsystem 12 is communicatively coupled to the local warning system 20 and the remote warning system 22. The local warning system 20 can include any of a variety of local notification devices that notify an individual at or around the vehicle. Moreover, these local notifications can be either or both of interior vehicle notifications and exterior vehicle notifications. Interior vehicle notifications are those notifications presented within an interior cabin of the vehicle, or those that are directed to individuals within an interior cabin of the vehicle. Exterior vehicle notifications are those notifications presented outside the vehicle, or those that are directed to individuals located outside of the vehicle. Examples of local notification devices include audio speakers, vehicle horn(s), lights (e.g., light emitting diodes (LEDs), headlights, turn signals, cabin lights, other vehicle lights), and haptic sensors (e.g., haptic sensors installed in a driver's seat that cause vibrations when activated). In one embodiment, any one or more of the local notification devices may be those installed as a part of manufacturing of the vehicle or those installed as a part of the vehicle evacuation drill monitoring system 10.

The remote warning system 22 may include any of a variety of remote notification devices that notify an individual that is located remotely from the vehicle. An example of a remote notification device is a cellular chipset that can send messages over a cellular network to other devices, such as a cellular telephone (e.g., smartphone), a remote server, or other remote device. In one embodiment, the cellular chipset can be used to send a short message service (SMS) message and/or an email to one or more designated individuals, such as a fleet manager, which is discussed more below. Additionally or alternatively, the cellular chipset can be used to make a voice call to one or more designated individuals, such as the fleet manager. And, in another embodiment, the cellular chipset can be used to send information or data to a remote server, such as a backend vehicle occupant detection system server that provides remote (or cloud) functionality for the vehicle evacuation drill monitoring system 10. Additionally or alternatively, a short-range wireless communications (SRWC) circuit or chipset can be used to provide the system 10 with SRWC capabilities, which can be used to send and/or receive messages between a remote user and the system 10. Various SRWC technologies can be used including Wi-Fi™, Bluetooth™ (including Bluetooth™ Low Energy), Zigbee™, Z-wave, other IEEE 802.11 techniques, other IEEE 802.15 techniques, infrared techniques, etc. For example, a Wi-Fi™ router can be provided at a school and the system 10 can establish a Wi-Fi™ connection with the Wi-Fi™ router. In at least some embodiments, the Wi-Fi™ router can be connected to one or more devices, and can be used to connect the system 10 to the Internet or other network. As another example of a remote notification device, a two-way radio can be used. Circuitry for implementing the two-way radio can be installed as a part of the vehicle evacuation drill monitoring system 10 and used to provide communications between the system 10 and one or more remote users.

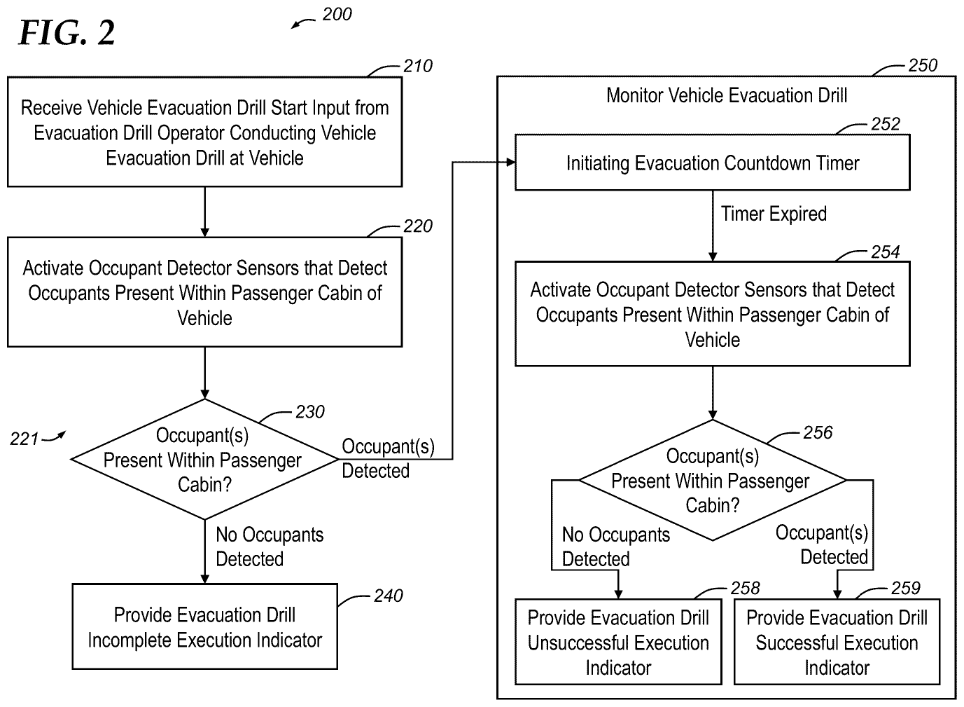

Each of the one or more occupant detection sensors 16 is an electronic sensor that is used to detect human occupancy of a space or region, and various types of sensors may be used. In one embodiment, the one or more occupant detection sensors 16 are life detection sensors. The life detection sensors may be used to detect a human within a particular region of the vehicle, such as through detection of microwaves as taught by U.S. Pat. No. 10,457,161 B2, which teaches a radar sensor system and method for ascertaining whether a human, such as an unattended child, is present within the vehicle. U.S. Pat. No. 10,457,161 B2 is hereby incorporated by reference the discussion of the radar sensor system and method, including the detection system of FIG. 1 as well as FIGS. 2-14 and their corresponding discussion in the written specification.

The vehicle evacuation drill monitoring system 10 can include any number N of occupant detection sensors 16, each of which is individually identified in FIG. 1 using the templated string “16−n” where n is an integer between 1 and N, N being the total number of sensors 16. In one embodiment, each of the life detection sensors may be a passive sensors that receives microwaves, light, or other electromagnetic waves/signals. Or, each of the life detection sensors may be an active sensor that includes a transmitter that emits electromagnetic waves/signals toward a passenger area of the vehicle, such as a passenger standing area or a seating area (or other area in which an occupant may be located) within an associated life detection zone. One or more reflected electromagnetic signals are then received at a receiver of the life detection sensor, and these reflected signal(s) can be sampled and/or otherwise processed by the life detection sensor. In one embodiment, the life detection sensors are each a radar unit that uses microwave technology. The radar unit can be any of a variety of radar units and, in one embodiment, can include a plurality of antenna elements for transmitting the electromagnetic signals and/or a plurality of antenna elements for receiving reflected electromagnetic signal(s). In one particular example, the radar includes a 4×2 antenna array; however, other configurations, including those with a different number of antennas, can be used. In some embodiments, separate antennas can be used for transmitting and receiving; however, in other embodiments, a single antenna can be used for both transmitting and receiving. In another embodiment, acoustic signals can be transmitted and received. In yet another embodiment, a passive sensor for the life detection sensors can be used in which the life detection sensors do not transmit acoustic or electromagnetic waves, but receive signals (e.g., electromagnetic waves, acoustic waves), such as a camera or microphone.

The vehicle evacuation drill monitoring system 10 also includes the battery 18. The battery 18 provides electrical power to various components of the vehicle evacuation drill monitoring system 10, including, for example, the controller subsystem 12, the occupant detection sensors 16, the local warning system 20, and the remote warning system 22. In embodiments, including the illustrated embodiment, the battery 18 can be a separate battery that is dedicated for the vehicle evacuation drill monitoring system 10, which can be an after-market device/system that is installed on a vehicle. In other embodiments, the battery 18 can be a vehicle battery—e.g., a 12V battery that is included as a part of the vehicle electrical system.

With reference to FIG. 2, there is shown an embodiment of a method 200 of carrying out an evacuation drill for a vehicle in which occupants are evacuated from the vehicle. The method 200 is carried out by the vehicle evacuation drill monitoring system 10, at least in some embodiments.

The method 200 begins with step 210, wherein a vehicle evacuation drill start input is received from an evacuation drill operator. The evacuation drill operator is the person conducting a vehicle evacuation drill at a vehicle and, where more than one person is conducting the vehicle evacuation drill, the evacuation drill operator is any one or more of the persons conducting the vehicle evacuation drill. The vehicle evacuation drill start input is an input used to initiate a vehicle evacuation drill at a vehicle. In embodiments, the vehicle evacuation drill start input is received at the controller 14 from any suitable HMI input device, such as from a mobile device (e.g., smartphone) that sends a wireless message (e.g., Wi-Fi™, Bluetooth™, cellular SMS). In other embodiments, the evacuation drill operator presses a pushbutton that is wired to the controller in a manner so that the controller detects depression of the pushbutton. The method 200 continues to step 220.

Steps 220-240 represent a fake evacuation drill detection mechanism or process 221 that is used to determine whether there are occupants present within the passenger cabin of the vehicle prior to beginning an evacuation phase of the evacuation drill.

In step 220, occupant detection sensors that detect occupants present within a passenger cabin of vehicle are activated. For example, in one embodiment, the controller 14 sends a sensor capture request to each of the occupant detection sensors 16 via the communications bus 30. According to other embodiments, other suitable form of communication between the controller 14 and the occupant detection sensors 16 may be used. The method 200 continues to step 230.

In step 230, it is determined whether occupants are present within the passenger cabin of the vehicle. The occupant detection sensors 16 provide a sensor capture result to the controller 14, indicating whether there was a positive detection or not—that is, whether an occupant was detected or not. The sensor capture result may be in any of a variety of forms when received from the occupant detection sensor 16; for example, the sensor capture result may include raw sensor measurements that are then interpreted at the controller 14; in other embodiments, the sensor capture result output by the occupant detection sensors 16 provides a clear indication with minimal to no processing being required as the sensor capture result itself directly indicates a positive or negative detection. When no occupants are detected, the method 200 continues to step 240; otherwise, the method 200 continues to step 250.

In step 240, an evacuation drill incomplete execution indicator is provided to an evacuation drill operator, such as the same evacuation drill operator that provided the vehicle evacuation drill start input. The evacuation drill incomplete execution indicator indicates to the evacuation drill operator that the vehicle evacuation drill was not performed or at least was not fully performed and so is therefore considered incomplete. According to embodiments, the any “indicator” discussed herein to be provided to a person may be provided using any suitable HMI output device, such as an audio speaker, graphics on a display (e.g., on the evacuation drill operator's smartphone), etc. The method 200 then ends, although one or more steps (or the entire method) may be repeated in order to attempt to complete a vehicle evacuation drill at the vehicle. Accordingly, the fake evacuation drill detection mechanism or process 221 enables verification that occupants are located within the vehicle (specifically, the passenger cabin) at or prior to the start of an evacuation phase of the evacuation drill.

In step 250, an evacuation phase of the vehicle evacuation drill begins and is monitored. This step 250 begins with step 252, wherein an evacuation countdown timer is initiated. The evacuation countdown timer defines a temporal extent of an evacuation phase of the evacuation drill in which one or more occupants are to evacuate a passenger cabin of the vehicle. The evacuation countdown timer may be predefined/predetermined, such as through setting the evacuation countdown timer to a fixed value, such as 5 or 10 minutes. In other embodiments, the evacuation drill operator may specify an amount of time for the evacuation countdown timer. The method 200 continues to step 254.

In step 254, it is determined whether occupants are present within the passenger cabin of the vehicle and, in step 256, it is determined whether occupants are present within the passenger cabin of the vehicle. These steps 254, 256 are analogous to steps 220 and 230, respectively, and the discussion of those steps 220, 230 is hereby incorporated and attributed to steps 254, 256 to the extent that discussion is not inconsistent with the express discussion of steps 254, 256. When no occupants are detected, the method 200 continues to step 258; otherwise, the method 200 continues to step 259.

In step 258, an evacuation drill unsuccessful execution indicator is provided to an evacuation drill operator, such as the same evacuation drill operator that provided the vehicle evacuation drill start input and/or other indicators. The evacuation drill unsuccessful execution indicator indicates to the evacuation drill operator that the vehicle evacuation drill was performed and resulted in an unsuccessful end result in that an occupant was detected at the end of an evacuation phase of a vehicle evacuation drill.

In step 259, an evacuation drill successful execution indicator is provided to an evacuation drill operator, such as the same evacuation drill operator that provided the vehicle evacuation drill start input and/or other indicators. The evacuation drill successful execution indicator indicates to the evacuation drill operator that the vehicle evacuation drill was performed and resulted in a successful end result in that no occupants were detected at the end of an evacuation phase of a vehicle evacuation drill.

The step 240 is analogous in operation to each of steps 258, 259, although the indicators and the information they indicate is different, and so that corresponding disclosure of the step 240 is hereby incorporated and attributed to each of steps 258, 259 to the extent that discussion is not inconsistent with the express discussion of steps 258, 259. The method 200 then ends, although one or more steps (or the entire method) may be repeated in order to attempt to carry out a successful vehicle evacuation drill (such as when the first iteration resulted in an evacuation drill unsuccessful execution indicator).

It is to be understood that the foregoing description is of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” and “such as,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all the following: “A”; “B”; “C”; “A and B”; “A and C”; “B and C”; and “A, B, and C.”

1. A method of carrying out an evacuation drill for a vehicle in which occupants are evacuated from the vehicle, wherein the method is performed by a computer subsystem having at least one processor and memory storing computer instructions that, when executed by the at least one processor, cause the method to be performed, and wherein the method comprises the steps of:
receiving a vehicle evacuation drill start input from an evacuation drill operator conducting a vehicle evacuation drill at a vehicle;
initiating an evacuation countdown timer that defines a temporal extent of an evacuation phase of the vehicle evacuation drill in which one or more occupants are to evacuate a passenger cabin of the vehicle;
upon expiration of the evacuation countdown timer, determining whether any occupants remain within the passenger cabin of the vehicle through use of occupant detection sensors installed within the vehicle; and
providing an indicator indicating whether the vehicle evacuation drill was successful.

2. The method of claim 1, further comprising, when it is determined that no occupants remain within the passenger cabin of the vehicle, providing an evacuation drill successful execution indicator as the indicator and for indicating that the vehicle evacuation drill was successful.

3. The method of claim 1, further comprising, when it is determined that an occupant remains within the passenger cabin of the vehicle, providing an evacuation drill unsuccessful execution indicator as the indicator and for indicating that the vehicle evacuation drill was unsuccessful.

4. The method of claim 1, further comprising the step of:
determining whether any occupants are located within the passenger cabin of the vehicle prior to initiating the evacuation countdown timer.

5. The method of claim 4, wherein the determination of whether any occupants are located within the passenger cabin of the vehicle prior to initiating the evacuation countdown timer is performed through use of the occupant detection sensors installed within the vehicle.

6. The method of claim 4, further comprising the step of:
initiating the evacuation countdown timer when it is determined that there is at least one occupant located in the passenger cabin of the vehicle.

7. The method of claim 4, further comprising the step of:
providing an evacuation drill incomplete execution indicator to the evacuation drill operator when it is determined that there is at least one occupant located in the passenger cabin of the vehicle.

8. The method of claim 4, wherein the determination of whether any occupants are located within the passenger cabin of the vehicle prior to initiating the evacuation countdown timer is used for identifying whether the passenger cabin of the vehicle is in a ready state for performing the vehicle evacuation drill and/or whether the vehicle evacuation drill is being faked.

9. The method of claim 1, further comprising the step of providing results of the vehicle evacuation drill to a data management hub that is configured to obtain vehicle evacuation drill results from a plurality of vehicle evacuation drill monitoring systems including a first vehicle evacuation drill monitoring system having the computer subsystem and being for the vehicle.

10. A method of carrying out an evacuation drill for a vehicle in which occupants are evacuated from the vehicle, wherein the method is performed by a computer subsystem having at least one processor and memory storing computer instructions that, when executed by the at least one processor, cause the method to be performed, and wherein the method comprises the steps of:
receiving a vehicle evacuation drill start input from an evacuation drill operator conducting a vehicle evacuation drill at a vehicle;
in response to receiving the vehicle evacuation drill start input, activating electronic occupant detection sensors that detect occupants present within a passenger cabin of the vehicle;
determining whether one or more occupants are present within the passenger cabin based on sensor data from the occupant detection sensors;
when it is determined that there are no occupants present within the passenger cabin, providing an evacuation drill incomplete execution indicator indicating that the evacuation drill is incomplete;
when it is determined that there are one or more occupants present within the passenger cabin:
initiating an evacuation countdown timer that defines a temporal extent of an evacuation phase of the evacuation drill in which the one or more occupants are to evacuate the passenger cabin of the vehicle;
upon expiration of the evacuation countdown timer, determining whether any occupants remain within the passenger cabin of the vehicle through use of occupant detection sensors installed within the vehicle;
when it is determined that no occupants remain within the passenger cabin of the vehicle, providing an evacuation drill successful execution indicator indicating that the evacuation drill was successful; and
when it is determined that an occupant remains within the passenger cabin of the vehicle, providing an evacuation drill unsuccessful execution indicator indicating that the evacuation drill was unsuccessful.

11. A vehicle evacuation drill monitoring system for a vehicle, comprising:
a computer subsystem having at least one processor and memory storing computer instructions; and
one or more occupant detection sensors installed on the vehicle;
wherein the computer subsystem is configured to execute the computer instructions using the at least one processor in order to:
receive a vehicle evacuation drill start input from an evacuation drill operator conducting a vehicle evacuation drill at a vehicle;
initiate an evacuation countdown timer that defines a temporal extent of an evacuation phase of the vehicle evacuation drill in which one or more occupants are to evacuate a passenger cabin of the vehicle;
upon expiration of the evacuation countdown timer, determine whether any occupants remain within the passenger cabin of the vehicle through use of the one or more occupant detection sensors installed within the vehicle; and
provide an indicator indicating whether the vehicle evacuation drill was successful.

12. The vehicle evacuation drill monitoring system of claim 11, wherein the computer subsystem is further configured to execute the computer instructions using the at least one processor in order to, when it is determined that no occupants remain within the passenger cabin of the vehicle, provide an evacuation drill successful execution indicator as the indicator and for indicating that the vehicle evacuation drill was successful.

13. The vehicle evacuation drill monitoring system of claim 11, wherein the computer subsystem is further configured to execute the computer instructions using the at least one processor in order to, when it is determined that an occupant remains within the passenger cabin of the vehicle, provide an evacuation drill unsuccessful execution indicator as the indicator and for indicating that the vehicle evacuation drill was unsuccessful.

14. The vehicle evacuation drill monitoring system of claim 11, wherein the computer subsystem is further configured to execute the computer instructions using the at least one processor in order to determine using the one or more occupant detection sensors whether any occupants are located within the passenger cabin of the vehicle prior to initiating the evacuation countdown timer.

15. The vehicle evacuation drill monitoring system of claim 14, wherein the determination of whether any occupants are located within the passenger cabin of the vehicle prior to initiating the evacuation countdown timer is performed through use of the one or more occupant detection sensors installed within the vehicle.

16. The vehicle evacuation drill monitoring system of claim 14, wherein the computer subsystem is further configured to execute the computer instructions using the at least one processor in order to initiate the evacuation countdown timer when it is determined that there is at least one occupant located in the passenger cabin of the vehicle.

17. The vehicle evacuation drill monitoring system of claim 14, wherein the computer subsystem is further configured to execute the computer instructions using the at least one processor in order to provide an evacuation drill incomplete execution indicator to the evacuation drill operator when it is determined that there is at least one occupant located in the passenger cabin of the vehicle.

18. The vehicle evacuation drill monitoring system of claim 14, wherein the determination of whether any occupants are located within the passenger cabin of the vehicle prior to initiating the evacuation countdown timer is used for identifying whether the passenger cabin of the vehicle is in a ready state for performing the vehicle evacuation drill and/or whether the vehicle evacuation drill is being faked.

19. The vehicle evacuation drill monitoring system of claim 11, wherein the computer subsystem is further configured to execute the computer instructions using the at least one processor in order to provide results of the vehicle evacuation drill to a data management hub that is configured to obtain vehicle evacuation drill results from a plurality of vehicle evacuation drill monitoring systems including a first vehicle evacuation drill monitoring system having the computer subsystem and being for the vehicle.

20. The vehicle evacuation drill monitoring system of claim 11, wherein the vehicle is a school bus or other mass-transit vehicle, and wherein the computer subsystem is installed on the school bus or other mass-transit vehicle.
